(19) United States
(12) Patent Application Publication
(10) Pub. No.: US 2026/0010599 A1
(43) Pub. Date: Jan. 8, 2026

(54) USER AUTHENTICATION METHOD AND APPARATUS USING INPUT PATTERN INFORMATION

(71) Applicants: KAKAOBANK CORP., Seongnam-si (KR); KOREA UNIVERSITY RESEARCH AND BUSINESS FOUNDATION, Seoul (KR)

(72) Inventors: Daehee HAN, Seongnam-si (KR); Donghwa SHIN, Seongnam-si (KR); Pilsung KANG, Seoul (KR); Jaehyuk HEO, Seoul (KR); Jeongseob KIM, Seoul (KR); Euisuk CHUNG, Seoul (KR); Subin KIM, Hwaseong-si (KR)

(21) Appl. No.: 19/137,418

(22) PCT Filed: Nov. 30, 2023
(86) PCT No.: PCT/KR2023/019548

§ 371 Date: Jun. 10, 2025

(30) Foreign Application Priority Data
Dec. 12, 2022 (KR) 10-2022-0172939

(51) Int. Cl. G06F 21/31

(52) U.S. Cl. CPC G06F 21/316

(57) ABSTRACT

The present invention provides user authentication method and apparatus using input pattern information. The user authentication method using input pattern information according to an implementation, comprising: constructing input data by collecting the input pattern information of a subject using the user device; transforming a data space of the input data by inputting the input data into a data space transformation model; and outputting a user authentication result of the subject by analyzing the input data in which the data space is transformed using a classification model.

### TECHNICAL FIELD

The present invention relates to a user authentication method and apparatus using input pattern information. More specifically, the present invention relates to a user authentication method and apparatus capable of providing a more secure financial service environment by collecting input pattern information of a subject during the process in which the subject inputs authentication information and performing user authentication for the subject based on the collected input pattern information.

### BACKGROUND

The matters described in this section are merely provided for background information for the present embodiment and do not constitute the related art.

As financial institutions or electronic financial service providers provide financial products and services through computing devices, non-face-to-face financial transactions conducted online, without requiring the user to directly interact with the personnel of the financial institution or electronic financial service provider, are increasingly prevalent.

In the non-face-to-face financial transactions method, customers request financial transactions through their own terminals, such as computers and smartphones, and confirm the results of the financial transactions through their respective terminals. In such non-face-to-face financial transaction procedures, user authentication for the entity requesting the non-face-to-face financial transactions is required to ensure security and safety.

Typically, user authentication can be performed through authentication information set in advance by the user. For example, the authentication information may include passwords, patterns, certificate information, or biometric information such as fingerprints. However, as non-face-to-face financial transaction technologies have advanced, technologies for hacking or replicating authentication means have also developed, and the risk of authentication means being exposed to others or being hacked has increased.

In particular, when information related to the authentication means of multiple users is stored and managed on a single server, there is a risk that the authentication means of multiple users may be exposed to the outside due to an attack or hacking of the server.

Accordingly, there is a demand for a user authentication method capable of providing a safer and more secure financial service environment, thereby supporting the activation of non-face-to-face financial transactions and enabling stable execution of such non-face-to-face financial transactions.

### DETAILED DESCRIPTION OF THE INVENTION

### Technical Problem

An object of the present invention is to provide a user authentication method and apparatus using input pattern information, which enables a user to perform non-face-to-face financial transactions more securely by performing user authentication based on the user's input pattern information.

In addition, an object of the present invention is to provide a user authentication method and apparatus using input pattern information, which enables individual training of an authentication model while protecting the subject's privacy and personal information.

In addition, an object of the present invention is to provide a user authentication method and apparatus using input pattern information, including an authentication model that can provide efficient training of a classification model and high classification performance by performing spatial transformation of data prior to data classification through a classification model.

Furthermore, an object of the present invention is to provide a user authentication method and apparatus using input pattern information, which can construct an authentication model with enhanced classification performance and consistency through a normalization process on the collected data.

The objects of the present invention are not limited to those mentioned above, and other objects and advantages of the present invention that are not mentioned can be understood from the following description and will be more clearly understood through the embodiments of the present invention. Furthermore, it will be easily understood that the objects and advantages of the present invention can be realized by the means and combinations thereof shown in the claims.

### Solution to Problem

A user authentication method using input pattern information according to an embodiment of the present invention for achieving the above technical task, comprising: constructing input data by collecting the input pattern information of a subject using the user device; transforming a data space of the input data by inputting the input data into a data space transformation model; and outputting a user authentication result of the subject by analyzing the input data in which the data space is transformed using a classification model.

In addition, the input pattern information comprises: spatial information in which authentication information is input on an input interface; and temporal information related to a time in which the authentication information is input on the input interface.

In addition, the constructing of the input data comprises: calculating time normalization information using the spatial information and the temporal information; and constructing the input data using at least one of the spatial information, the temporal information, and the time normalization information.

In addition, the data space transformation model is a model pre-trained such that user data follows a specific distribution in a latent space.

In addition, the data space transformation model is configured as a normalizing flow trained such that the user data forms a normal distribution in the latent space, and in the transforming of the data space, the input data is projected to a specific location in the latent space by the trained normalizing flow of the data space transformation model.

In addition, the data space transformation model is configured as an autoencoder trained to project features extracted from the user data into the latent space and to reconstruct data identical or similar to the user data based on the projected features, and in the transforming of the data space, features are extracted from the trained autoencoder to which the input data is applied, and the features are projected to a specific location in the latent space.

In addition, the classification model is a machine learning model-based classification model trained to determine whether the subject corresponds to a pre-registered user based on the input data with the transformed data space.

In addition, further comprising: storing the input data input to the data space transformation model and output data output from the data space transformation model corresponding to the input data as first training data; and storing the transformed input data input to the classification model and output data output from the classification model corresponding to the transformed input data as second training data.

In addition, further comprising: determining whether an authentication model including the data space transformation model and the classification model is in a trainable state; and training the data space transformation model with the first training data and training the classification model with the second training data if the authentication model is in the trainable state.

In addition, further comprising: deleting the first training data on which training of the data space transformation model has been completed and the second training data on which training of the classification model has been completed.

Furthermore, the user authentication method using the input pattern information is performed on the user device that stores and uses the data space transformation model and the classification model in memory or storage.

Moreover, further comprising: providing a financial service environment provided by a financial server to the subject when user authentication of the subject is completed.

A device according to an embodiment of the present invention for achieving the above technical task, comprising: a processor; a memory loading a computer program executed by the processor; and a storage storing the computer program, wherein the computer program comprises: constructing input data by collecting the input pattern information of a subject using the user device; transforming a data space of the input data by inputting the input data into a data space transformation model; and outputting a user authentication result of the subject by analyzing the input data in which the data space is transformed using a classification model.

A recording medium according to an embodiment of the present invention for achieving the above technical task, is may be read by a computer on which a program capable of executing the method is recorded.

### Effect of the Invention

The user authentication method and apparatus using input pattern information according to an embodiment of the present invention can support users in more securely performing non-face-to-face financial transactions by performing user authentication using the user's input pattern information.

In addition, the present invention is configured such that training data used for training is deleted after training is completed on the user device (i.e., the system operates on-device), thereby enabling individual training of the authentication model while protecting the subject's privacy and personal information.

Further, the present invention can provide efficient training of the classification model and high classification performance by performing spatial transformation of data prior to data classification through the classification model.

Moreover, the present invention can construct an authentication model with improved classification performance and consistency through normalization of the collected data.

In addition to the aforementioned, the specific effects of the invention will be described in detail while explaining the specific aspects of implementing the invention.

### BRIEF DESCRIPTION OF THE DRAWINGS

FIG. 1 is a conceptual diagram illustrating a user device according to some embodiments of the present invention.

FIG. 2 is a conceptual diagram illustrating the relationship between the user device and a financial server according to some embodiments of the present invention.

FIG. 3 is a flowchart illustrating a user authentication method using input pattern information according to some embodiments of the present invention.

FIG. 4 is an exemplary view for explaining input pattern information.

FIG. 5 illustrates the detailed steps of constructing input data by collecting the input pattern information of the subject.

FIG. 6 is an exemplary view for explaining a process of generating time normalization information using spatial and temporal information.

FIG. 7 is an exemplary view showing the structure of an authentication model according to some embodiments of the present invention.

FIG. 8 is an exemplary view for explaining a process of training a data space transformation model configured as a normalizing flow.

FIG. 9 is an exemplary view for explaining the concept of space transformation between a variable x corresponding to input data and a variable z representing a latent space in the normalizing flow.

FIG. 10 is an exemplary view for explaining a process in which users are distinguished through a trained data space transformation model (normalizing flow).

FIG. 11 is an exemplary view for explaining a data space transformation model configured as an autoencoder.

FIG. 12 is an exemplary view showing a process of classifying data through a classification model in a state before data space transformation is performed.

FIG. 13 is an exemplary view showing a process of classifying data through a classifier in a state where data space transformation has been performed.

FIG. 14 shows the result of comparing and analyzing the performance of an authentication model according to the input data.

FIG. 15 is a flowchart illustrating detailed steps of training an authentication model in a user authentication method using input pattern information according to some embodiments of the present invention.

FIG. 16 is an exemplary diagram for explaining the relationship between an inference process and an authentication process.

FIG. 17 is a diagram for explaining a hardware implementation of a device for performing a user authentication method using input pattern information according to some embodiments of the present invention.

### FORM FOR IMPLEMENTATION OF THE INVENTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application.

In addition, each configuration, procedure, process, method, or the like included in each embodiment of the disclosure may be shared to the extent that they are not technically contradictory to each other.

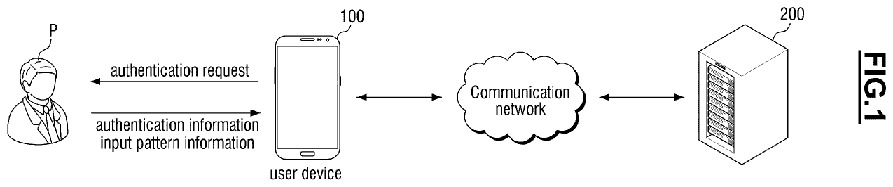

Hereinafter, the user authentication method and apparatus using input pattern information according to some embodiments of the present invention will be described with reference to FIGS. 1 to 17.

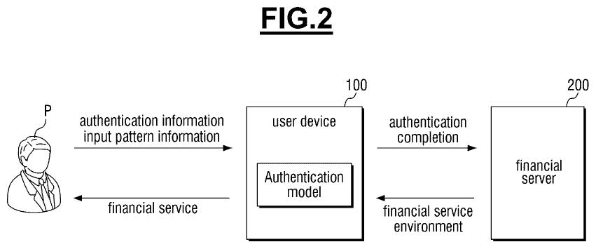

FIG. 1 is a conceptual diagram illustrating a user device according to some embodiments of the present invention. FIG. 2 is a conceptual diagram illustrating the relationship between the user device and a financial server according to some embodiments of the present invention.

Referring to FIG. 1, a user device 100 may be configured to provide a financial service environment provided by a financial server 200 to a subject P.

The user device 100 refers to a communication terminal capable of operating a financial application in a wired or wireless communication environment. In an embodiment, the user device 100 may be a portable terminal of a user. That is, the user device 100 may be a smartphone, which is a type of portable terminal. However, the user device 100 is not limited thereto and may be applied to any device capable of mounting a financial application that can provide the financial service environment of the financial server 200, receiving user input, and outputting financial services to the user.

For example, the user terminal 100 may include various types of electronic devices such as a personal computer (PC), a notebook, a tablet, a mobile phone, a smartphone, or a wearable device (e.g., a watch-type terminal).

The user device 100 and the financial server 200 may exchange data through a communication network. The communication network may provide a connection path such that the user device 100 can access the financial server 200 and transmit and receive data. The communication network may include, for example, wired networks such as LANs (Local Area Networks), WANs (Wide Area Networks), MANs (Metropolitan Area Networks), and ISDNs (Integrated Service Digital Networks), as well as wireless networks such as wireless LANs, CDMA, Bluetooth, and satellite communication, but the scope of the present invention is not limited thereto.

The subject P may be an entity intending to use the financial service environment provided by the financial server 200 using the user device 100. Specifically, the financial service environment provided by the financial server 200 may include a plurality of user accounts, and the subject P may be an entity intending to use financial services related to one of the user accounts. That is, the subject P may be a user of the user account. However, the subject is not limited thereto and may be an intruder attempting to access the user account without authorization.

The user device 100 may request user authentication from the subject P. In a case where the subject P performs user authentication and the authentication is successfully performed, the user device 100 may provide a financial transaction related to a specific user account to the subject P. In an embodiment, the user device 100 may include an input/output device (not shown) configured to output a user interface requesting authentication information and to receive the input from the subject P. Here, the input/output device may include at least one of a pad, keypad, keyboard, mouse, touchpad, touchscreen, and display device, but is not limited thereto.

Here, personalized input characteristics of the user may appear during the process of inputting authentication information through the input/output device of the user device 100. For example, when the input/output device is a touchscreen, the location and time of touching the touchscreen may differ depending on the user. In this specification, the personalized input characteristics that appear when a user inputs authentication information or specific information through the input/output device are defined as “input pattern information.”

The user device 100 may collect the input pattern information of the subject P during the process in which the subject P performs the procedure for user authentication. Specifically, the user device 100 may collect the input pattern information of the subject P and the authentication information input by the subject P during the process in which the subject P inputs the authentication information for user authentication.

In the present invention, user authentication of the subject P may be performed based on the input pattern information. In some embodiments, user authentication may be performed based on at least one of the authentication information and the input pattern information collected through the input/output device. In some embodiments, whether the authentication information collected through the input/output device matches the authentication information of a specific user account may first be determined, and user authentication may be performed by further analyzing the input pattern information of the subject P whose authentication information matches. That is, compared to conventional authentication methods and systems that perform user authentication only based on the match between the collected authentication information and the authentication information stored in advance, the security and safety of user authentication can be significantly enhanced.

In some embodiments, the user device 100 may include an authentication model for performing user authentication of the subject based on the input pattern information of the subject, and the user authentication of the subject may be performed using this authentication model.

Referring to FIG. 2, the user device 100 may be configured as an on-device system including the authentication model. The authentication model may be included in the user device 100, rather than in the financial server 200. Instead of the conventional analysis method in which the information collected by the user device 100 is transmitted to a central server (the financial server 200 or a separate analysis server) for analysis and the analyzed result is received, the user device 100 may be configured to collect and process information locally. That is, since information is processed internally in the terminal device, it is possible to perform fast operations with low latency and also to resolve security issues such as leakage or hacking of authentication information of multiple users at once.

When user authentication of the subject P is successfully performed using the included authentication model, the user device 100 may transmit authentication completion to the financial server 200. In response to the authentication completion provided by the user device 100, the financial server 200 may provide the financial service environment related to a specific user to the user device 100. The user device 100 may output the provided financial service environment through the input/output device and provide the financial transactions to the subject P.

Further, in some embodiments, the user device 100 may be configured to further perform training of the included authentication model. The user device 100 may collect the input pattern information of the subject P for user authentication and may perform training of the authentication model using the collected input pattern information and user authentication results. Through this, the discrimination and accuracy of the authentication model can be further enhanced. Once training is completed, the collected training data may be discarded, thereby further improving the privacy protection and security of the subject.

In summary, the user device 100 according to some embodiments of the present invention may be an on-device-based device that performs user authentication of the subject by analyzing the input pattern information of the subject using the authentication model.

However, the embodiments of the present invention are not limited thereto. In some embodiments, the authentication model may be included in the financial server 200, and the user authentication for the authentication information and input pattern information provided from the user device 100 may be performed by the financial server 200. However, the present specification describes an on-device-based user authentication method, and therefore, the following description will primarily focus on embodiments in which the user authentication method is performed by the user device 100.

The financial server 200 may provide the financial service environment related to a specific user to the user device 100, along with authentication completion when user authentication of the subject is successfully performed.

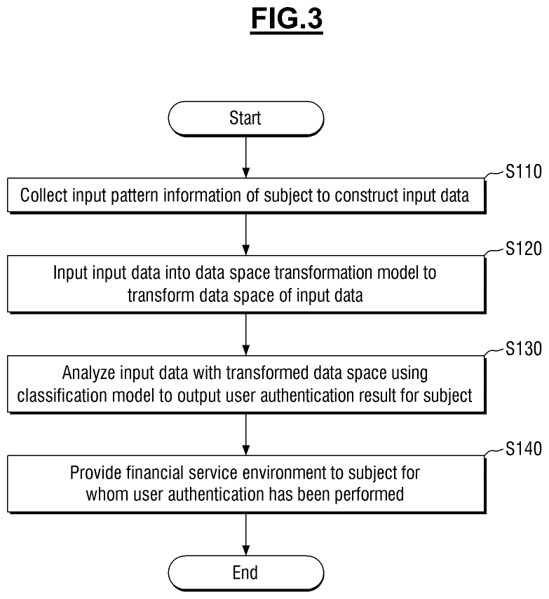

Hereinafter, with reference to FIGS. 3 to 14, a user authentication method using input pattern information according to some embodiments of the present invention will be described in detail. The method according to the embodiment may be performed by the user device 100 or the financial server 200.

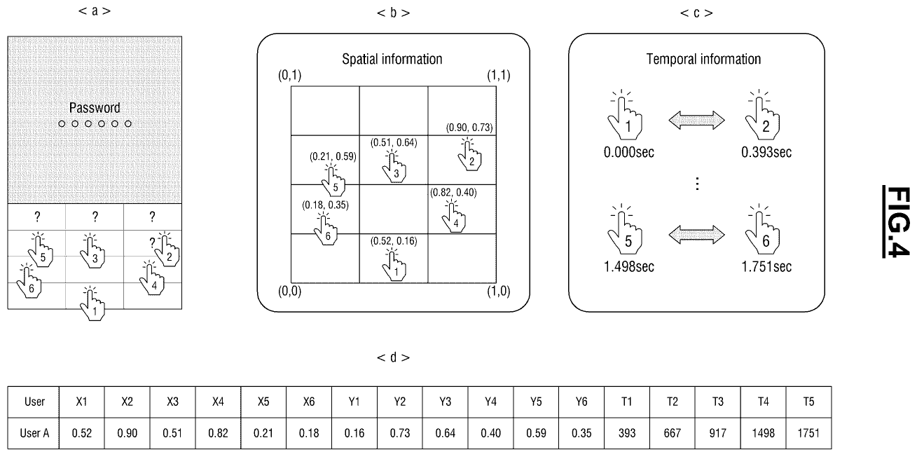

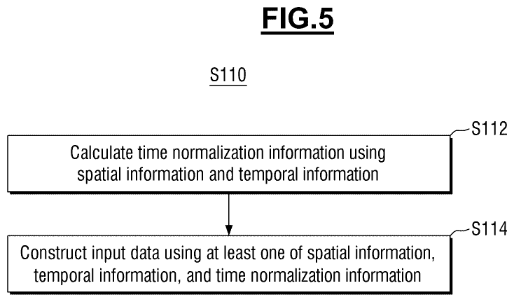

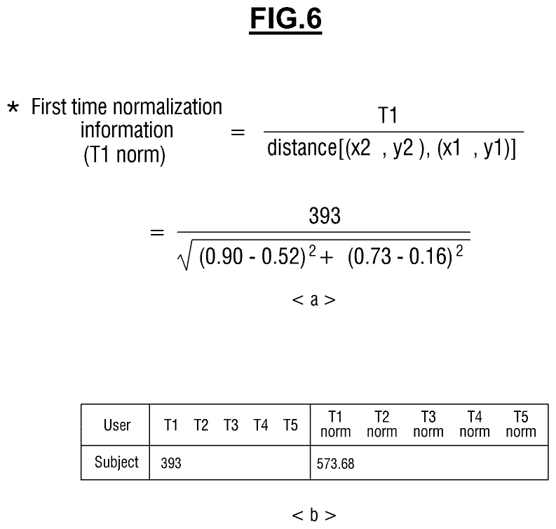

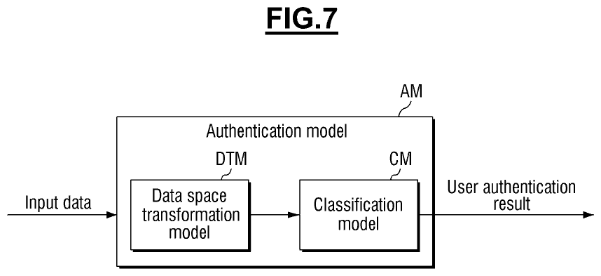

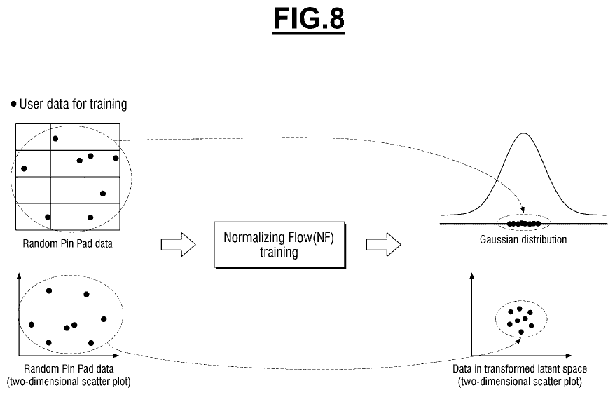

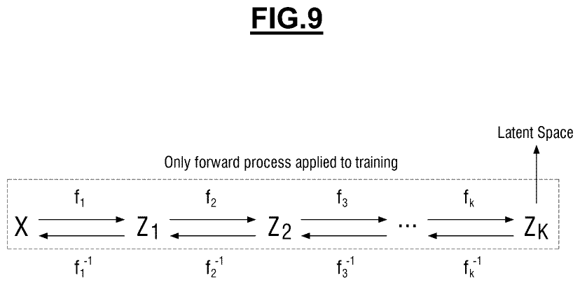

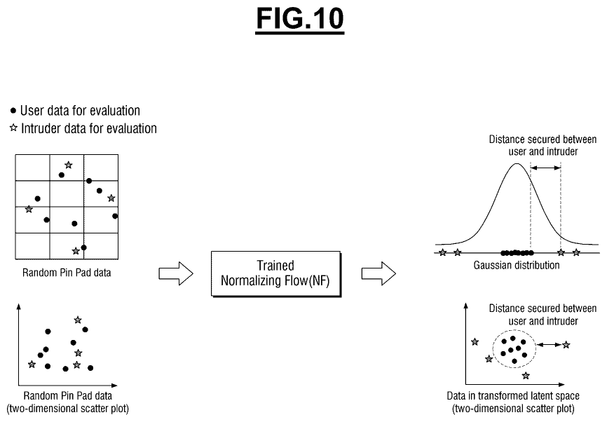

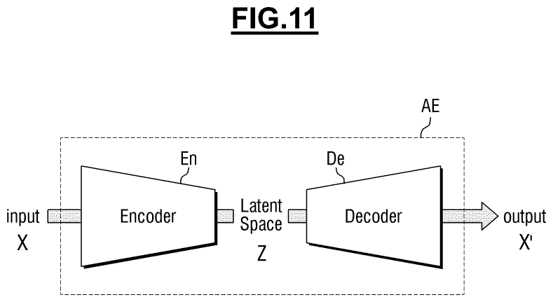

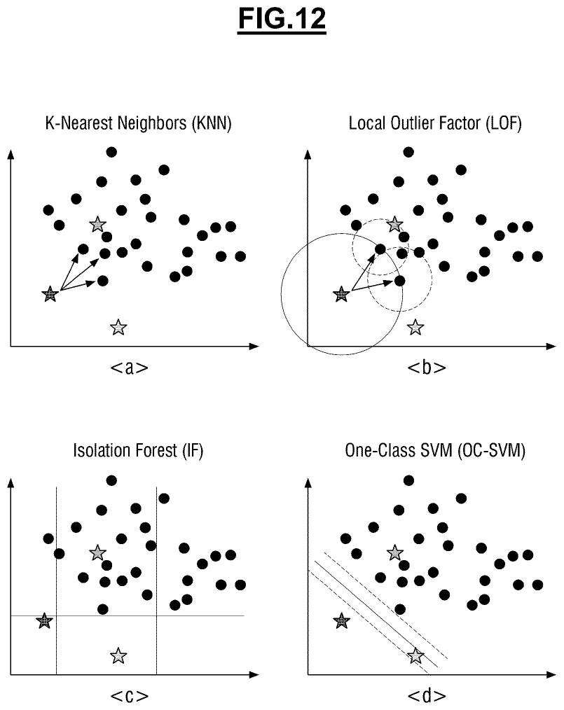

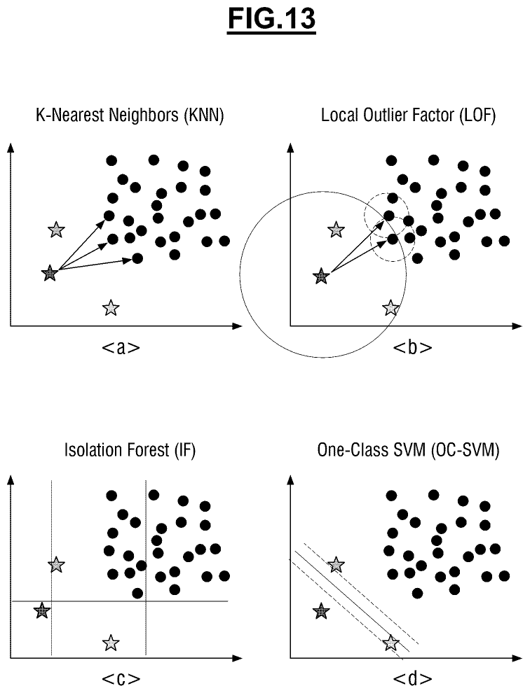

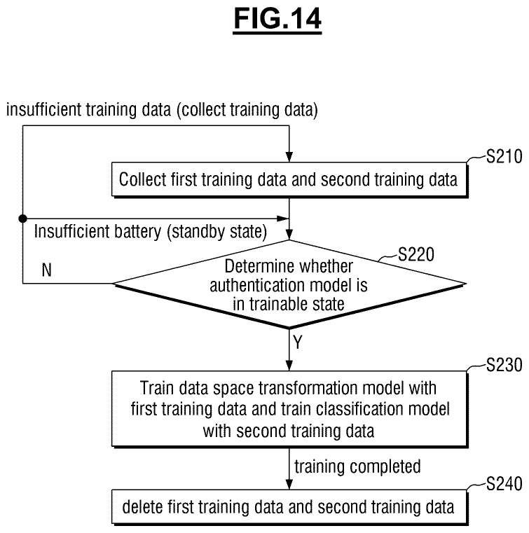

FIG. 3 is a flowchart illustrating a user authentication method using input pattern information according to some embodiments of the present invention. FIG. 4 is an exemplary view for explaining input pattern information. FIG. 5 illustrates the detailed steps of constructing input data by collecting the input pattern information of the subject. FIG. 6 is an exemplary view for explaining a process of generating time normalization information using spatial and temporal information. FIG. 7 is an exemplary view showing the structure of an authentication model according to some embodiments of the present invention. FIG. 8 is an exemplary view for explaining a process of training a data space transformation model configured as a normalizing flow. FIG. 9 is an exemplary view for explaining the concept of space transformation between a variable x corresponding to input data and a variable z representing a latent space in the normalizing flow. FIG. 10 is an exemplary view for explaining a process in which users are distinguished through a trained data space transformation model (normalizing flow). FIG. 11 is an exemplary view for explaining a data space transformation model configured as an autoencoder. FIG. 12 is an exemplary view showing a process of classifying data through a classification model in a state before data space transformation is performed. FIG. 13 is an exemplary view showing a process of classifying data through a classifier in a state where data space transformation has been performed. FIG. 14 shows the result of comparing and analyzing the performance of an authentication model according to the input data.

Referring to FIG. 3, a user authentication method using input pattern information according to some embodiments of the present invention includes step S110 of collecting input pattern information of a subject to construct input data, step S120 of inputting the input data into a data space transformation model to transform the data space of the input data, and step S130 of analyzing the input data with the transformed data space through a classification model and outputting a user authentication result for the subject.

First, the input pattern information of the subject is collected to construct input data (S110).

The subject P may input authentication information for user authentication of a user account to be used. The subject P may be a user who is using the user device 100 for authentication of the user account. During the process in which the subject P inputs authentication information, the subject's input pattern information may be collected. Here, the authentication information may include a password, a pattern, certificate information, or biometric information such as a fingerprint. During the process of inputting such authentication information, the subject P may exhibit personalized input characteristics, and such personalized input characteristics may be collected as input pattern information in step S110.

The input pattern information may include spatial information of the space in which the authentication information is input on the input interface. In one embodiment, the input interface may provide input icons for inputting authentication information. For example, the input icons may be configured to occupy a certain space on the input interface, and the space of the input icons may be defined by X-Y plane coordinates. Although the coordinate axes used in the present invention are not limited to X-Y coordinates, for convenience of explanation, the X-Y plane coordinate axes will be used hereinafter as an example.

The subject may input authentication information by interacting (touching or clicking) with the spatial coordinates of the input icons, and the spatial coordinates X-Y with which the user interacts may be collected as spatial information of the input pattern information.

In some embodiments, the authentication information may be a password composed of a plurality of digits, and the input interface may provide the subject with numeric icons enabling users to input numbers corresponding to digits 0 to 9, as shown in FIG. 4A.

The subject may select a plurality of digits in sequence from the numeric icons corresponding to the password. Each numeric icon on the input interface may be located at a preset space, and the X-Y plane coordinates for each space may be set. The subject may interact with the spatial coordinates of each numeric icon on the input interface by touching or clicking, and the corresponding digit may be input. Here, even if multiple users input the digit 6 as part of the authentication information, the X-Y plane coordinates with which each user interacts (touch or click) on the digit 6 icon may differ. Therefore, such spatial information may be utilized as information representing the personalized input characteristics of each user. For example, if the authentication information is a password composed of six digits, six X-Y plane coordinates may be collected as spatial information based on the interactions with six numeric icons, as shown in FIG. 4B.

Additionally, the input pattern information may include temporal information related to the time in which the authentication information is input on the input interface. The time taken to input authentication information through the input interface may vary depending on the user. Therefore, such temporal information may be utilized as information representing the personalized input characteristics of each user. Here, the temporal information may refer to the total time taken to input the authentication information. However, the embodiments of the present invention are not limited thereto.

In some embodiments, the authentication information may be configured to be related to a plurality of input icons on the input interface. The plurality of input icons may sequentially interact with the subject according to the authentication information, and the time in which the interaction with each icon is performed may be collected. In one embodiment, as shown in FIG. 4C, the temporal information may refer to the time difference between the interaction time of a preceding icon and the interaction time of a succeeding icon. For example, when the authentication information is a password composed of six digits, X-Y plane coordinates may be collected as spatial information based on interactions with the six numeric icons, and the time differences between the collection times of each spatial coordinate may be collected as temporal information.

In step S110, the collected input pattern information as described above may be configured as input data.

For example, spatial information X1, X2, . . . , X6 and Y1, Y2, . . . , Y6 and temporal information T1, T2, . . . , T5 collected according to the process in which the subject inputs a password composed of six digits may be configured as input data corresponding to the subject, as shown in FIG. 4D.

In some embodiments, step S110 may modify the collected input pattern information to configure additional input data. Such input data corresponds to the data input into an AI-based authentication model in the subsequent steps S120 and S130. In one embodiment, the authentication model used in steps S120 and S130 may be pre-trained based on the input data configured in step S110.

Referring to FIG. 5, step S110 may include step S112 of calculating temporal normalization information using the spatial information and the temporal information and step S114 of configuring input data using at least one of the spatial information, temporal information, and temporal normalization information.

In step S112, temporal normalization information may be calculated using the spatial information and the temporal information. Such temporal normalization information may provide prior knowledge to the AI-based authentication model, thereby further specifying prior distributions for parameters and restricting the set of trainable functions. This can prevent overfitting of the authentication model and enable more accurate predictions.

In step S112, the temporal normalization information may be calculated by dividing the time in which consecutive pieces of spatial information are collected by the distance between the consecutive pieces of spatial information. For example, as illustrated in FIG. 6A, first temporal normalization information (T1 norm) corresponding to first time (T1) may be calculated by dividing first time (T1) by the distance between the second spatial information X2, Y2 and the first spatial information X1, Y1. Temporal normalization information (T norm) corresponding to each time may be calculated in step S112.

In step S114, input data is configured using at least one of the spatial information, temporal information, and temporal normalization information.

*Step S114 may be a step of configuring input data to be input into the prediction model and performing preprocessing on the configured input data. In one embodiment, the input data may be configured using at least one of the spatial information, temporal information, and temporal normalization information. In some embodiments, the input data may be configured to include all of the collected spatial information and temporal information as well as the calculated temporal normalization information. However, the embodiments of the present invention are not limited thereto. As shown in the example of FIG. 6B, the input data may also be configured to include the temporal information and the temporal normalization information.

Referring again to FIG. 3, steps S120 and S130 of performing user authentication using the configured input data are executed.

In an embodiment of the present invention, the authentication model may be pre-trained based on user data related to a specific user. Here, the user data may refer to input data previously input by a user corresponding to a specific user account that the subject intends to use. Multiple sets of input data may be collected from the conventional user of the user account during the process of inputting authentication information, and the authentication model may be pre-built and trained based on such input data. In one embodiment, the authentication model may be pre-built and trained individually for each user account.

Referring to FIG. 7, the authentication model (AM) may include a data space transformation model (DTM) and a classification model (CM). In the authentication model (AM), the data space transformation model (DTM) and the classification model (CM) may operate sequentially. The data may first be transformed in space to have a specific distribution by the data space transformation model (DTM), and classification of the transformed data may then be performed using the classification model (CM). Hereinafter, the processes of training each of the data space transformation model (DTM) and the classification model (CM), and the steps of analyzing the subject's input data using the trained models will be described together.

First, the input data configured in the previous step S110 is input into the data space transformation model (DTM), and the data space of the input data is transformed (S120).

Here, the transformation of the data space may refer to projection into a latent space. The data space transformation model may transform the input data space such that pieces of input data having identical or similar characteristics are located adjacently and form clusters in the latent space. That is, through the data space transformation model (DTM), the input data may be moved to a space where pieces of data having identical or similar characteristics are projected.

In step S120, the data space transformation model (DTM) may be pre-trained based on the user data. In other words, the data space transformation model (DTM) corresponds to a model trained such that user data related to a specific user is spatially moved within a certain range in the transformed latent space. Here, the data space transformation model (DTM) may be a pre-trained model so that the user data follows a specific distribution in the latent space. In some embodiments, such a data space transformation model (DTM) may be configured based on a generative model.

Specifically, in some embodiments, the data space transformation model (DTM) may be configured using a normalizing flow. The normalizing flow can implement the space transformation by allowing the input data, through a series of invertible transformations through training, to have latent vector values that follow a Gaussian distribution. That is, in step S120, the input data of the subject may be projected to a specific location in the latent space by the trained normalizing flow.

Referring to FIG. 8, training is performed on the normalizing flow such that pieces of user data used for training form a Gaussian distribution. In the spatial information and two-dimensional scatter plot of the example user data shown, it can be seen that pieces of user data are spatially dispersed. The normalizing flow may be trained such that such pieces of user data form a Gaussian distribution within the latent space.

FIG. 9 illustrates the concept of space transformation between input variables X and variables Z representing the latent space in the normalizing flow. Here, the input variable X represents user data in the training process. Referring to FIG. 9, the input variable X may be transformed into a final latent space Zₖ through at least one normalization function f. Here, the final latent space may refer to a space where a Gaussian distribution is formed. As shown in FIG. 9, the latent space may be composed of a plurality of layers that move sequentially, and data transformation between latent spaces may be performed through corresponding normalization functions. That is, the normalizing flow may be understood as including a sequence of such normalization functions, and training of the normalizing flow may be a process of configuring the normalization functions so as to increase the probability that the input data is transformed to form a Gaussian distribution. In addition, such normalization functions f may be invertible functions that have reversible characteristics and can be transformed into inverse functions f⁻¹, and reconstruction of the input variables based on data arranged in the latent space may be performed through inverse functions.

An objective function of the normalizing flow according to an embodiment of the present invention for optimizing the process illustrated in FIG. 9 may be expressed as Equation 1.

$$log {p}_{x} ( x ) = log {p}_{2} ( {z}_{k} ) + {\sum }_{i = 1}^{k} log \vert det \frac{\partial {f}_{i} ( x )}{\partial {z}_{i - 1}} \vert \qquad [ Equation 1 ]$$

Here, Pₓ denotes the probability density function of input data x, and P_{z} denotes the probability density function of the data z projected into the latent space, which forms a Gaussian distribution at zₖ. k represents the number of layers in the normalizing flow and is a natural number of 1 or greater, and f represents the normalization function.

Through the process of optimizing the above-described objective function, training of the normalizing flow may be performed. The trained normalizing flow may induce a specific distance to be formed between the user data used in training and data from others not used in training.

Referring to FIG. 10, it can be seen that, although evaluation user data and evaluation intruder data are distributed in a dispersed space, the pieces of data are moved in the latent space transformed by the trained normalizing flow such that they form a Gaussian distribution. In addition, it can be seen that the evaluation user data and evaluation intruder data are located so that a certain distance is secured in the latent space through the trained normalizing flow.

Furthermore, in some embodiments of the present invention, the data space transformation model (DTM) may be implemented as an autoencoder. That is, in step S120, when the input data of the subject is applied to a trained autoencoder, features may be extracted from the autoencoder and the extracted features may be projected to a specific location in the latent space.

Referring to FIG. 11, the data space transformation model (DTM) is configured as an autoencoder (AE) and may include an encoder (En) and a decoder (De).

The encoder (En) may extract features from the input data X and move the extracted data into the latent space z. In the embodiment, the encoder (En) may be trained such that the features extracted from the input data X are projected to identical or similar locations in the latent space. The decoder (De) may be trained to reconstruct data identical or similar to the input data based on the features projected into the latent space and may output the reconstructed output data X′ as the output data. In some embodiments, the decoder (De) may output the reconstructed output data X′ such that the pieces of reconstructed identical or similar output data are located in identical or similar spaces. In the embodiment, the autoencoder (AE) may be trained for both the encoder (En) and the decoder (De) such that the difference between the input data X and the reconstructed data X′ is minimized.

The autoencoder (AE), sufficiently trained using user data, may extract the features of the user data and the features of the intruder data (not from the user) such that the respective features are projected into different latent spaces, and may reconstruct the respective pieces of data so that they are distinguished as different pieces of data based on the extracted features and output the reconstructed data as output data. In the embodiment, the decoder (De) of the autoencoder (AE) may output the output data reconstructed based on the user data and the output data reconstructed based on the intruder data such that they are located at different positions in the data space.

In some embodiments, the data space transformation model (DTM) may be configured to partially or wholly utilize the trained autoencoder (AE) as described above. That is, the data space transformation model (DTM) may be configured such that the encoder (En) is partially utilized by the trained autoencoder (AE) and the feature values moved to the latent space are then used by a classification model (CM) described later. That is, the classification model (CM) receives the feature values classified in the latent space as input, classifies the feature values, and outputs a user authentication result accordingly. However, the configuration is not limited thereto, and the data space transformation model (DTM) may also be configured to use the entire trained autoencoder (AE), allowing the classification model (CM) described later to utilize the output data output from the decoder (De). That is, the classification model (CM) may receive the output data output into the data space by the decoder (De) as input, classify the output data, and output a user authentication result accordingly.

Next, the input data with the transformed data space is analyzed by a classification model, and a user authentication result for the subject is output (S130).

In step S130, the classification model (CM) analyzes the input data with the transformed data space and outputs a user authentication result for the subject. The classification model (CM) may analyze the projected input data to classify whether the subject is the user according to the user account or a third party (intruder) who is not the user. That is, the user authentication result output from the classification model (CM) may be a result of classifying whether the subject is the user or not.

In the embodiment, the classification model (CM) may be a machine learning model-based classification model trained to determine whether the input data projected into the latent space corresponds to the user. In some embodiments, the classification model (CM) may be implemented using machine learning models such as linear regression, logistic regression, decision trees, one-class support vector machines (OC-SVM), naive Bayes, K-nearest neighbors (KNN), K-means clustering, isolation forests, local outlier factor (LOF), random forests, dimensionality reduction algorithms, gradient boosting algorithms, neural networks (e.g., convolutional, recurrent, perceptron, long short-term memory (LSTM), Hopfield, Boltzmann, deep belief, deconvolution, generative adversarial, liquid state machines, etc.), and/or other types of machine learning models.

Here, the classification model (CM) may analyze input data projected into a latent space by the data space transformation model (DTM). That is, the input data may be moved to a specific location in the latent space through the data space transformation model (DTM), and classification by the classification model (CM) may be facilitated in such a state. In other words, by implementing the data space transformation model (DTM) together with the classification model (CM), rather than using the classification model (CM) alone to classify input data, it is possible to enhance the overall training effect and classification performance of the model.

FIG. 12 is an exemplary view showing a process of classifying data through a classification model in a state before data space transformation is performed, and FIG. 13 is an exemplary view showing a process of classifying data through a classifier in a state where data space transformation has been performed. In FIGS. 12 and 13, A denotes a K-nearest neighbors (KNN) classification model that determines the category of new data by checking the neighboring data, B denotes a local outlier factor (LOF) classification model that determines the category of new data based on outliers detected in a local area, C denotes an isolation forest classification model that determines the category of data by splitting the data to isolate all observations, and D denotes a one-class support vector machine (OC-SVM) classification model that computes an optimal support vector capable of best describing given data to classify the data. These classification models are illustratively used to classify first data (★) and second data (•).

In each example shown in FIGS. 12 and 13, the first data (★) and the second data (•) represent different types of data, and the classification model must be trained to classify the first data (★) and the second data (•).

Referring to FIG. 12, it can be seen that prior to the execution of the data space transformation, the first data (★) and the second data (•) are spatially intermixed. Therefore, in order to distinguish between the first data (★) and the second data (•), there was a problem in that it was necessary to construct a classification model capable of distinguishing detailed and specific states, which required more data and training.

Referring to FIG. 13, it can be seen that, in the case where a transformation process is performed on the data through the data space transformation model (DTM), spatial separation is achieved between the first data (★) and the second data (•). Through such spatial separation between the first data (★) and the second data (•), the criteria for training the learning model may become clearer, thereby supporting more efficient training of the classification model. Furthermore, as a result of such efficient training, a classification model capable of providing more accurate classification performance may be constructed.

In step S130, classification of the data projected into the latent space is performed using the classification model constructed as described above, and a user authentication result for the subject is output.

The user authentication method according to some embodiments of the present disclosure may further include a step of collecting additional authentication information of the subject. Step S130 may include performing user authentication based on the collected authentication information of the subject and the user authentication result output by the authentication model. In an exemplary embodiment, step S130 may include first determining whether the authentication information of the user account matches the collected authentication information of the subject, and performing user authentication based on the user authentication result of the subject whose authentication information is matched.

Referring again to FIG. 3, in step S130, when user authentication of the subject is completed, a financial service environment provided from the financial server is provided to the subject (S140).

In step S140, a financial service environment corresponding to the user account is provided to the subject whose user authentication was completed in the previous step S130.

FIG. 14 illustrates the results of measuring the accuracy of the authentication model according to variously configured input data. In each embodiment, the authentication model includes a data space transformation model configured as a normalizing flow (NF) and a classification model configured as KNN.

In Example 1, the authentication model was constructed using spatial information as input data, and the accuracy was measured. In Example 2, the authentication model was constructed using temporal information as input data, and the accuracy was measured. In Example 3, the authentication model was constructed using time normalization information as input data, and the accuracy was measured. In Example 4, the authentication model was constructed using both spatial and temporal information as input data, and the accuracy was measured. In Example 5, the authentication model was constructed using both spatial information and time normalization information as input data, and the accuracy was measured. In Example 6, the authentication model was constructed using both temporal information and time normalization information as input data, and the accuracy was measured. In Example 7, the authentication model was constructed using spatial information, temporal information, and time normalization information together as input data, and the accuracy was measured.

For each example, the accuracy was measured in terms of integrated error and equal error rate. Referring to FIG. 14, it can be seen that Example 2, which utilizes temporal information, shows improved accuracy compared to Example 1, which utilizes spatial information. Additionally, compared to examples that use single types of information, Examples 5, 6, and 7, which consider normalized information such as time normalization information, show significant accuracy improvement. In particular, it can be seen that Example 7, which implements the authentication model using spatial information, temporal information, and time normalization information all together as input data, provides the highest accuracy.

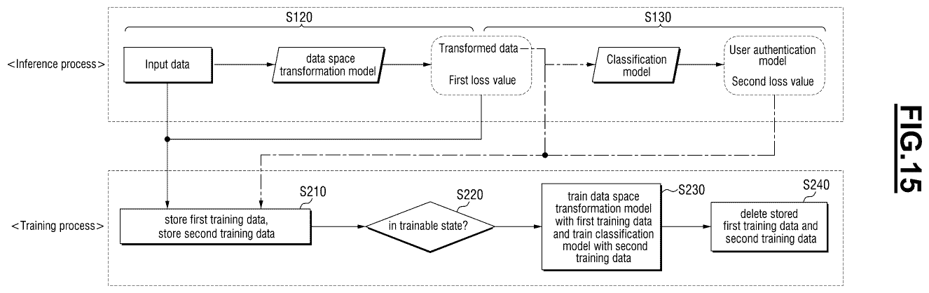

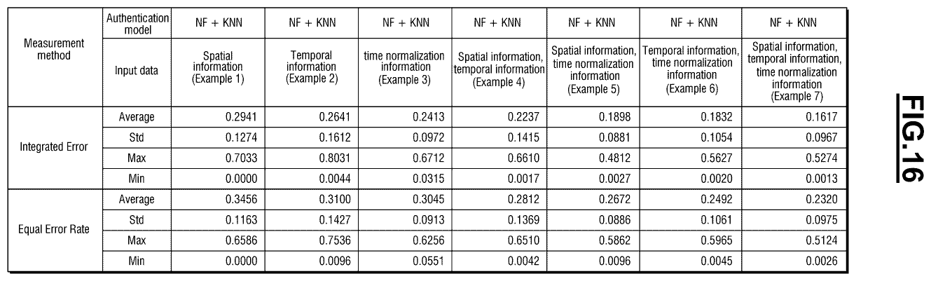

Here, the user authentication method using input pattern information according to some embodiments of the present invention may further include a process of training the authentication model. Hereinafter, with reference to FIGS. 15 and 16, a process in which training of the authentication model is performed on the user device will be exemplarily described.

FIG. 15 is a flowchart illustrating detailed steps of training an authentication model in a user authentication method using input pattern information according to some embodiments of the present invention. FIG. 16 is an exemplary diagram for explaining the relationship between an inference process and an authentication process.

Referring to FIGS. 15 and 16, the user authentication method using input pattern information according to some embodiments of the present invention includes step S210 of storing training data, step S220 of determining whether the authentication model is in a trainable state, step S230 of training the authentication model with training data when the authentication model is in a trainable state, and step S240 of deleting the training data.

In an embodiment, steps S210 to S240 may be performed on a device including the authentication model. In some embodiments, steps S210 to S240 may be performed on the user device 100 including the authentication model, but the embodiments of the present invention are not limited thereto. In another embodiment, the authentication model may be included in the financial server 200, and steps S210 to S240 may be performed on the financial server 200.

First, training data is collected and stored (S210).

The training data may be collected and stored during steps S120 and S130, in which inference and determination are performed on the input data of the subject. That is, as shown in FIG. 16, the data collected during the process of performing user authentication for the subject by sequentially inputting the subject's input data into the data space transformation model and inputting the output result from the data space transformation model into the classification model may be stored as training data.

Specifically, step S210 may include a step of storing the subject's input data and the output data output from the data space transformation model in response to the input data as first training data. That is, the training data may include the first training data composed of the input data and the output data from the data space transformation model. In step S120 according to the inference process, the data space transformation model may output the output data based on the input data. The input data input to the data space transformation model and the output data output from the data space transformation model are collected as first training data.

Here, the output data of the data space transformation model may include the input data with the transformed data space (hereinafter referred to as spatially transformed data) and a first loss value indicating a difference between the value predicted by the data space transformation model based on the input data and an actual value. In an embodiment, when the data space transformation model is configured as a normalizing flow, the first loss value may be composed of the Negative Log-Likelihood (NLL) for the objective function of the input data x according to Equation 1. Additionally, when the data space transformation model is configured as an autoencoder, the first loss value may correspond to the difference between the input data x and the reconstructed data x′. During the inference process, the input data, the spatially transformed data, and the first loss value may be collected and stored as the first training data.

In an embodiment, step S210 may include a step of storing, as second training data, the spatially transformed data output from the data space transformation model and the output data that is output by inputting the spatially transformed data into the classification model. In step S130 according to the inference process, the classification model may output the output data according to the input spatially transformed data. The input data input into the classification model and the output data output from the classification model are collected as the second training data.

The output data output from the classification model may include a user authentication result that is the result of analyzing the spatially transformed data and a second loss value indicating a difference between a value predicted by the classification model according to the spatially transformed data and an actual value. During the inference process, the spatially transformed data, the user authentication result, and the second loss value may be collected and stored as second training data.

Next, it is determined whether the authentication model is in a trainable state (S220).

In step S220, it may be determined whether the stored training data is sufficient. Further, it may be determined whether sufficient power is available in the device to perform training of the authentication model. If the respective amounts of the stored first training data and the second training data are equal to or greater than a predetermined amount, it may be determined that the amount of training data is sufficient. Additionally, if the user device 100 is in a charging state or if the battery level is above a certain level, it may be determined that the power is sufficient to perform training of the authentication model. For example, if the battery level of the user device 100 is measured to be 70% or more, it may be determined that the power is sufficient to perform training of the authentication model.

In step S220, if the amount of stored training data is determined to be insufficient, the process may return to the previous step S210 to collect additional training data. Also, in step S220, if it is determined that the power of the user device 100 is insufficient, the training of the authentication model may be suspended until the power of the device becomes sufficient. In particular, in the case of an on-device system in which the authentication model is included in the user device 100, determining whether the power of the device is sufficient may prevent the training of the authentication model from being interrupted due to power shortage and may prevent other devices or components from being affected by the power consumption caused by the training.

In some embodiments, step S220 may be executed periodically in a standby state to check the power status of the device. Furthermore, step S220 may include displaying an alarm to the user requesting a change in the power status of the user device 100 in the standby state.

If the stored training data is sufficient and the power is in a sufficient state in step S220, the process proceeds to step S230.

In step S230, the data space transformation model may be trained using the first training data, and the classification model may be trained using the second training data.

That is, based on the information collected through the inference process, additional training may be further performed on the authentication model (e.g., the data space transformation model and the classification model) included in the user device 100. Accordingly, an authentication model may be implemented that more accurately reflects the input pattern characteristics of the user and more effectively excludes subjects classified as intruders.

Subsequently, after the training of the authentication model is completed, the first training data and the second training data used for training are deleted (S240). The previously stored first training data and second training data may be discarded, thereby preventing the personal information of the subject from being exposed externally in advance. In particular, even when training is performed in the user device 100 in an on-device manner, the information used for training does not remain in the user device 100, so that, even if the user device 100 is lost or stolen, the personal information of the subject/user may be prevented from being leaked or exposed externally.

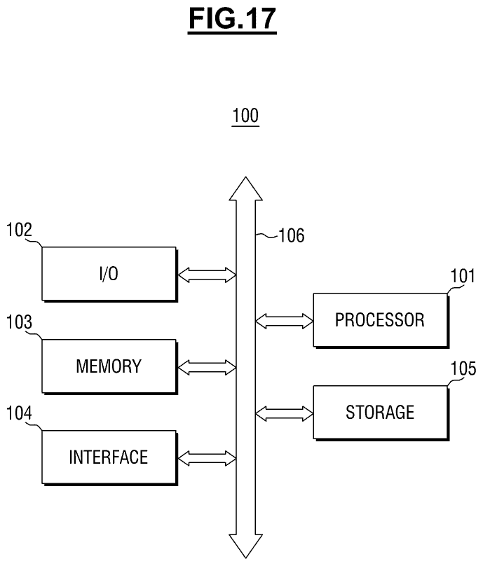

FIG. 17 is a diagram for explaining a hardware implementation of a device for performing a user authentication method using input pattern information according to some embodiments of the present invention.

Referring to FIG. 17, a device for performing a user authentication method using input pattern information according to some embodiments of the present invention may be implemented as an electronic device 1000. Here, the electronic device 1000 may be the user device 100, but is not limited thereto and may correspond to the financial server 200.

The electronic device 1000 may include a processor 1010, input/output (I/O) device 1020, a memory 1030, an interface 1040, a storage 1050, and a bus 1060. The processor 1010, the I/O device 1020, the memory 1030, the interface 1040, and/or the storage 1050 may be coupled to each other via the bus 1060. The bus 1060 corresponds to a path through which data is transferred.

Specifically, the processor 1010 may include at least one of logic elements such as a central processing unit (CPU), a micro processor unit (MPU), a micro controller unit (MCU), a graphic processing unit (GPU), a microprocessor, a digital signal processor, a microcontroller, an application processor (AP), or other elements performing similar functions.

The input/output device 1020 may include at least one of a keypad, a keyboard, a touchscreen, and a display device.

The memory 1030 may load data and/or programs. At this time, the memory 1030, as an operation memory for enhancing the operation of the processor 1010, may include high-speed DRAM and/or SRAM. The memory 1030 may include one or more volatile memory devices such as a double data rate synchronous DRAM (DDR SDRAM), a single data rate SDRAM (SDR SDRAM), and/or one or more non-volatile memory devices such as an electrically erasable programmable ROM (EEPROM), or a flash memory.

The interface 1040 may perform the function of transmitting data to and receiving data from a communication network. The interface 1040 may be wired or wireless. For example, the interface 1040 may include an antenna or a wired/wireless transceiver.

The storage 1050 may store and preserve data and/or programs. The storage 1050 may include one or more non-volatile memory devices such as a solid-state drive (SSD), a hard drive, or a flash memory. In the present invention, the storage 1050 may store a computer program composed of instructions for performing the aforementioned user authentication method.

In an embodiment, the computer program may include a step of collecting input pattern information of a subject to construct input data, a step of inputting the input data into a data space transformation model to transform the data space of the input data, and a step of analyzing the input data with the transformed data space through a classification model to output a user authentication result for the subject.

A user authentication method using input pattern information according to an embodiment may also be implemented in the form of a computer-readable medium that stores instructions and data executable by a computer. In this case, the instructions and data may be stored in the form of program codes and, when executed by a processor, may generate a predetermined program module to perform a predetermined operation. In addition, the computer-readable medium may be any available medium accessible by a computer, including both volatile and non-volatile media, and removable and non-removable media. The computer-readable medium may be a computer recording medium, which may include both volatile and non-volatile, and removable and non-removable media implemented in any method or technology for storage of information such as computer-readable instructions, data structures, program modules, or other data. For example, the computer recording medium may be magnetic storage media such as HDDs and SSDs, optical recording media such as CDs, DVDs, and Blu-ray discs, or memory included in a server accessible via a network.

Furthermore, the user authentication method using input pattern information according to an embodiment may also be implemented as a computer program (or computer program product) including computer-executable instructions. The computer program may include machine-executable instructions processed by a processor and may be implemented in a high-level programming language, an object-oriented programming language, an assembly language, or machine language. The computer program may be recorded on a tangible computer-readable recording medium (e.g., memory, hard disk, magnetic/optical media, or SSD (Solid-State Drive)).

The above description is merely an example of the technical idea of the present embodiment, and those with ordinary knowledge in the technical field to which the present embodiment belongs may make various modifications and variations without departing from the essential characteristics of the present embodiment. Therefore, the present embodiments are not intended to limit the technical idea of the present embodiment, but rather to explain it, and the scope of the technical idea of the present embodiment is not limited by these embodiments. The scope of protection of this embodiment should be interpreted by the claims below, and all technical ideas within a scope equivalent thereto should be interpreted as being included in the scope of protection of this embodiment.

1. A user authentication method using input pattern information performed on a user device, comprising:
constructing input data by collecting the input pattern information of a subject using the user device;
transforming a data space of the input data by inputting the input data into a data space transformation model; and
outputting a user authentication result of the subject by analyzing the input data in which the data space is transformed using a classification model,
wherein the data space transformation model is a model pre-trained such that user data follows a specific distribution in a latent space.

2. The method of claim 1, wherein the input pattern information comprises:
spatial information in which authentication information is input on an input interface; and
temporal information related to a time in which the authentication information is input on the input interface.

3. The method of claim 2, wherein the constructing of the input data comprises:
calculating time normalization information using the spatial information and the temporal information; and
constructing the input data using at least one of the spatial information, the temporal information, and the time normalization information.

4. (canceled)

5. The method of claim 1, wherein the data space transformation model is configured as a normalizing flow trained such that the user data forms a normal distribution in the latent space, and
in the transforming of the data space, the input data is projected to a specific location in the latent space by the trained normalizing flow of the data space transformation model.

6. The method of claim 1, wherein the data space transformation model is configured as an autoencoder trained to project features extracted from the user data into the latent space and to reconstruct data identical or similar to the user data based on the projected features, and
in the transforming of the data space, features are extracted from the trained autoencoder to which the input data is applied, and the features are projected to a specific location in the latent space.

7. The method of claim 1, wherein the classification model is a machine learning model-based classification model trained to determine whether the subject corresponds to a pre-registered user based on the input data with the transformed data space.

8. The method of claim 1, further comprising:
storing the input data input to the data space transformation model and output data output from the data space transformation model corresponding to the input data as first training data; and
storing the transformed input data input to the classification model and output data output from the classification model corresponding to the transformed input data as second training data.

9. The method of claim 8, further comprising:
determining whether an authentication model including the data space transformation model and the classification model is in a trainable state; and
training the data space transformation model with the first training data and training the classification model with the second training data if the authentication model is in the trainable state.

10. The method of claim 9, further comprising:
deleting the first training data on which training of the data space transformation model has been completed and the second training data on which training of the classification model has been completed.

11. The method of claim 1, wherein the user authentication method using the input pattern information is performed on the user device that stores and uses the data space transformation model and the classification model in memory or storage.

12. The method of claim 1, further comprising:
providing a financial service environment provided by a financial server to the subject when user authentication of the subject is completed.

13. A financial server comprising:
a processor;
a memory loading a computer program executed by the processor; and
a storage storing the computer program,
wherein the computer program comprises:
constructing input data by collecting input pattern information of a subject;
transforming a data space of the input data by inputting the input data into a data space transformation model; and
outputting a user authentication result of the subject by analyzing the input data in which the data space is transformed using a classification model,
wherein the data space transformation model is a model pre-trained such that user data follows a specific distribution in a latent space.

14. A computer-readable recording medium on which a program for executing the method according to claim 1 is recorded.
